(19) United States
(12) Patent Application Publication
(10) Pub. No.: US 2023/0316161 A1
(43) Pub. Date: Oct. 5, 2023

(54) SYSTEM AND METHOD FOR DETERMINING OPTIMAL PLACEMENT STRATEGY FOR RENTAL ACCOMMODATIONS

(71) Applicants: Alexander G. Narinsky, Newton, MA (US); Dimitar Aleksandrov Terzov, Pazardzhik (BG); Mushegh Davtyan, Yerevan (AM); Artur Asatryan, Yerevan (AM)

(72) Inventors: Alexander G. Narinsky, Newton, MA (US); Dimitar Aleksandrov Terzov, Pazardzhik (BG); Mushegh Davtyan, Yerevan (AM); Artur Asatryan, Yerevan (AM)

(73) Assignee: Alexander G. Narinsky, Newton, MA (US)

(21) Appl. No.: 18/115,042

(22) Filed: Feb. 28, 2023

Related U.S. Application Data
(60) Provisional application No. 63/325,178, filed on Mar. 30, 2022.

(51) Int. Cl. G06Q 10/02; G06Q 30/0645; G06Q 20/10

(52) U.S. Cl. CPC G06Q 10/02; G06Q 20/102; G06Q 30/0645

(57) ABSTRACT

A computer-implemented system and method for determining optimal placement strategy for rental accommodations. The system is executed in a computer-implemented environment, and comprises a server and a visitor device in communication. The server is configured to receive a request data for placement strategy from the visitor and determine one or more placement strategies based on the request data. The request data includes check-in date, check-out date, location of interest and one or more amenities specified either as mandatory or as useful. A visitor assigns criterial monetary values for useful but not necessary amenities, for commute from the lodging unit to the location of interest, for moving from one to another lodging unit. The placement strategy includes information about moving from one premise to another within the same trip, the amount of the customer’s payment, and a criterial value that allows the visitor to choose the best value placement strategy.

### CROSS-REFERENCE TO RELATED APPLICATION

The present application claims the benefit of U.S. provisional application U.S. 63/325,178 filed on 30 Mar. 2022 entitled “SYSTEM AND METHOD FOR SELECTING RESIDENTIAL PREMISES FOR TEMPORARY RENT”, the contents of which are hereby incorporated by reference.

### BACKGROUND OF THE INVENTION

### A. Technical Field

The present invention generally relates to booking accommodations for users, for example, visitors. More specifically, the present invention relates to a computer-implemented system and method for enabling the visitor to find optimal accommodation in terms of customer satisfaction, and for the host to maximize profit.

### B. Description of Related Art

Determining a placement strategy and booking accommodation is a typical step for visitors. Generally, the visitors research for accommodations with respect to the point of interest, or location of interest planned for visit. In addition, criteria such as availability, affordability, dining options, pet care and other criteria need to align with the determinedaccommodation.

Websites and applications such as Airbnb, VRBO, or Booking.com are some online services that facilitates the visitor to book accommodations. The visitor could browse through a number of accommodations near their point of interest and book accommodations. Further, the service facilitates the visitor to filter accommodation based on criteria such as accommodation date and location. Furthermore, the service facilitates the visitor to filter accommodation based on criteria such as amenities. Thereby, these services enable the visitor to search at least one location proximal to the point of interest, remotely and book accommodations.

As the consumer base continues to expand, their demand and preference also expand. In attempting to address the needs of visitors, it is important to maintain a minimal level of complexity for a given accommodation system. At the same time, effective management of the system by the owners is equally taken into consideration. One of the common accommodation problems is that the owners may have an extremely fragmented schedule for the utilization of premises. This fragmentation leads to the fact that at some time, very often some premises are not occupied. If the premises are empty, this leads to loss for the owners. Since the existent systems can only place the dates of residence in individual units and cannot schedule the transfer between units, they cannot fill in the empty premises and this results in the loss for owners and limiting options for visitors. Since the existing services do not calculate a monetary estimation for different options, visitors could miss optimally suited accommodations.

In addition, customers are only able to indicate their preference for amenities in a simple Yes (mandatory)/No form. For example, having a washing machine is certainly a plus, but it may not be absolutely necessary, as a customer can go to a laundry for washing, spending extra time and money on it. Existing systems do not allow specifying requirements to filters that are useful but not absolutely necessary.

In light of the above-mentioned problems, there is a need for a computer-implemented system and method for determining optimal placement strategy and booking accommodations taking into account.

### SUMMARY OF THE INVENTION

The present invention discloses a system for determining optimal placement strategy for rental accommodations. The system comprises a visitor device associated with a visitor, and a server comprising a database and a computing device in communication with the database. The server is in communication with the visitor device. The database is configured to store information related to a plurality of lodging units and the visitors. The computing device comprises a memory unit storing a set of modules and a processor configured to executed the modules. The set of modules comprises an input module, an analysis module, a booking module and a payment module.

The input module is configured to receive a request data for placement strategy from the visitor. The request data comprises check-in date, check-out date, a location of interests and optionally criteria (filters) for amenities. Criteria for amenities can be expressed either as mandatory requirements (must have) or as a monetary criterial value that is the penalty that a visitor imposes on a home for not having this particular amenity. In addition, the request data can have monetary criterial values for penalties that a customer imposes for moving during the total reservation either internally within the same location, i.e., a house (internal move penalty) or externally (external move penalty) to other location during the reservation. Moreover, a criterial monetary value can be assigned to a commute distance or time of an accommodation to the visitor’s point of interest, that is a penalty that the visitor imposes for the commute to the point of interest.

The analysis module is configured to determine one or more placement strategy based on the request data. Each placement strategy comprises one or more lodging units connected by either external or internal moves.

The first calculation phase is based on the Bellman Dynamic Programming Algorithm modified for finding several strategies to present a choice for a visitor. Every workflow node is defined by the unique combination of a rental unit and date. The system computes the target function for each node, which is a criterial value that takes into account aggregated room price, criterial value for moves and amenities.

By the end of calculation, the system presents variety of placement strategies that satisfies the customer date range. Each strategy comprises date of check-in and check-out of every lodging unit included into the placement. The placement strategies are sorted by the strategy criteria values, i.e., a score to represent an optimal level of the strategy. At the same time every placement strategy presents the monetary value, i.e., the price the customer needs to pay for accommodation.

The booking module is configured to enable the visitor to review one or more placement strategies and select one placement strategy. In case of internal moves the system optionally creates the reservation that unites reservations inside one address connected by internal moves to one reservation on the property, i.e., a parent property for saving booking fees. That means if a placement strategy contains internal movement between one lodging unit and another lodging unit, the system unites a reservation of for all lodging units using a parent property. The payment module is configured to enable visitor to pay for the chosen lodging. The payment is sent to the management firm that forwards part of the payment to a host.

Advantageously, the present invention’s system and method assists in determining the optimal accommodation rental unit or rental units for the visitor’s lodging based on the visitor requirements, such as the start and end dates, point of interest, and criterial values for amenities. It allows a visitor to select both a single-unit and multiunit placement strategy. In addition, it introduces the parent unit feature, which allows for the system to create one single booking for strategies with internal moves, this way it saves the expenses for extra reservation, such as the fixed fee from customer’s transaction fee, thus reducing the total amount of the booking. The algorithm and computer-implemented system and method allows the visitor to view multiple placement strategies and choose the most suitable plan. Furthermore, the technology assures high occupancy rate of premises filling the gaps in a fragmented premises schedule. The method is incorporated in the system comprising the server and the visitor device in communication with the server. The server comprises at least one computing device and at least one database for storing information related to the lodging unit and the visitors. The computing device comprises the memory unit storing a set of modules and the processor configured to executed the modules. The modules comprise the input module, the analysis module, the booking module and the payment module.

At one step, the input module receives a request data for placement strategy from the visitor. The request data comprises check-in date, check-out date, location of interest. The request data, optionally, comprises criteria for selected amenities, either expressed as Mandatory Yes/Required, or as a monetary penalty for not having this amenity, monetary value for lodging unit, monetary criterial value (penalty) for commute from the lodging unit to the location of interest, monetary criterial value for moving from one lodging unit to another lodging unit within one address (internal move) and monetary criterial value for moving from one lodging unit to another lodging unit with the different address (external move).

At another step, the analysis module determines one or more placement strategies based on the request data. Each placement strategy comprises one or more lodging units. The placement strategy further comprises date and time of check-in and check-out of each lodging unit. Each placement strategy further comprises a score (a criterial value that takes into account aggregated room price, monetary criterial value for moves and amenities) to represent an optimal level of the placement strategy, the score value enables the visitor to select optimal placement strategy.

At yet another step, the booking module enables the visitor to review one or more placement strategies and select one placement strategy. If the visitor selects movement between the one lodging unit and another lodging unit within one address, the system unites reservations of these units. At yet another step, the payment module enables the visitor to make payment for the selected lodging unit. The payment is sent to the management firm that forwards part of the payment to a host.

Other objects, characteristics, and benefits of the present invention will become clear from the thorough explanation that follows. However, the detailed description and specific examples, while indicating specific embodiments of the invention, are provided solely for illustration purposes, as various changes and modifications within the spirit and scope of the invention will be apparent to those skilled in the art from this detailed description.

### BRIEF DESCRIPTION OF DRAWINGS

The foregoing summary, as well as the entire description of the invention that follows, are more easily understood when read in combination with the associated drawings. Exemplary structures of the invention are given in the pictures to illustrate the invention. The invention, however, is not limited to the precise techniques and structures described herein. The description of a method step or structure denoted by a number in a picture is applicable to the description of that method step or structure denoted by that same numeral in any subsequent drawing herein.

FIG. 1 exemplarily illustrates an environment for determining optimal placement strategy and booking accommodations, according to an embodiment of the present invention.

FIG. 2 exemplarily illustrates an architecture of the environment of FIG. 1 for determining optimal placement strategy and booking accommodations, according to an embodiment of the present invention.

FIG. 3 exemplarily illustrates a block diagram of an accommodation management server, according to an embodiment of the present invention.

FIG. 4 shows an analysis table before finding a path using an algorithm, according to an embodiment of the present invention.

FIG. 5 shows two analysis tables after finding the path using the algorithm, each analysis table represents a placement strategy that is found according to an embodiment of the present invention.

FIG. 6 exemplarily illustrates a flowchart of a method for determining optimal placement strategy and booking accommodation, according to an embodiment of the present invention.

FIG. 7 shows a screenshot of a user interface for specifying amenities needed and optionally setting a criterial value for an Amenity by the visitor, according to an embodiment of the present invention.

FIG. 8 shows a screenshot of a user interface for optionally giving monetary value for internal move, external move and distance or time from the accommodation to the point of interest.

FIG. 9 shows a screenshot of different placement strategy specified by a score value, according to an embodiment of the present invention.

FIG. 10 shows a screenshot of a user interface of the visitor reservation that unites reservations inside one address connected by internal moves to one reservation on the property, or lodging unit, according to an embodiment of the present invention.

### DESCRIPTION OF EMBODIMENTS IN DETAIL

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

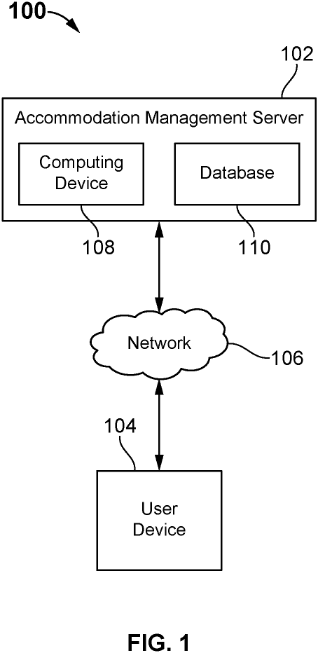

FIG. 1 exemplarily illustrates an environment 100 of a system for determining optimal placement strategy and booking accommodation, according to an embodiment of the present invention. The system is configured to provide at least one optimal placement strategy to the visitor. The system is further configured to facilitate the visitor to book an optimal accommodation using the optimal placement strategy. The system is configured to provide criterial value and monetary price of the placement strategy. The placement strategy comprises the sequence of lodging units and the information about movement dates between the lodging units.

The system comprises an accommodation management server 102, and a visitor device 104. The accommodation management server 102 is configured to provide service for determining optimal placement strategy and booking accommodation. The visitor device 104 is associated with the visitor. The visitor device 104 is in communication with the server 102 via a network 106. The visitor device 104 is a computing device configured to provide access to the service provided by the accommodation management server 102. The accommodation management server 102 is also referred as server 102.

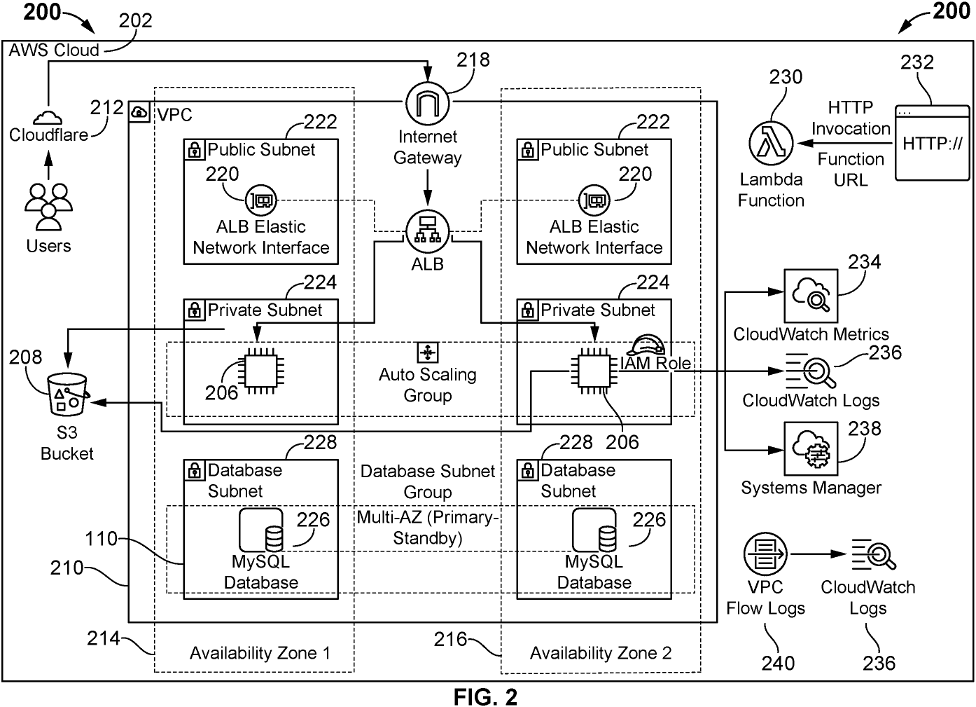

FIG. 2 exemplarily illustrates an architecture 200 of the environment 100 of FIG. 1 for determining optimal placement strategy and booking accommodations, according to an embodiment of the present invention. The system is executed in a computing environment. In one embodiment, the computing environment is a cloud computing environment, for example, AWS cloud 202. The system comprises the accommodation management server 102. In one embodiment, the server 102 is at least one of a general or special purpose computer. In an embodiment, the server 102 operates as a single computer, which can be a hardware and/or software server, a workstation, a desktop, a laptop, a mainframe, a supercomputer, a server farm, cloud hosting and so forth. In an embodiment, the computer could be touchscreen and/or non-touchscreen device and could run on any type of OS, such as iOS™, Windows™, Unix™, Linux™ and/or others. In an embodiment, the computer is in communication with network 106. Such communication can be via a software application, a mobile app, a browser, an OS, and/or any combination thereof. The accommodation management server 102 comprises a computing device 108 and at least one database 110.

In one embodiment, the computing device 108 may be one or more EC2 instances 206 which are provisioned and running in Private Subnets 224, which are secure and isolated from the internet. In one example, a software application is executed on an EC2 instance 206, it-interacts with a S3 bucket (Rent Optimum Bucket) 208 where artifacts for property images, visitor documents, etc., are stored and accessible by the application. The application running in the EC2 instances 206 establishes the connection with Amazon RDS 226 for MySQL database instance 110 running in the Private Subnet (Database Subnet) 228 and only allows connection request from the EC2 instances. For increased performance and high availability, VPC subnets (214, 216) span across two Availability Zones (AZs), which run the workload. Database instance stores and manages the information about properties’ availability, customer reviews, etc.

The visitor device 104 have the capability to provide the visitor an interface to interact with the services provided by the server 102. The interface, for example, a mobile application that allows the device 104 to wirelessly connect with the server 102 via the network 106. The visitor device 104 connects with the server 102 via internet/local network. The visitor device 104 may be, for example, a desktop computer, a laptop computer, a mobile phone, a personal digital assistant, and the like.

For increased security and performance, the visitor device 104 is configured to connect to the application running in the virtual private cloud (VPC) 210 through cloudflare® 212 service. From Cloudflare® 212, the requests are redirected to the amazon cloud 202 through internet gateway (IG) 218 and are sent to application load balancer (ALB) 220 in the public subnet 222. The ALB 220 directs the requests to EC2 instances 206 running in the two availability zones (AZs) (214, 216) for the application’s high availability and sends a response. The EC2 instances 206 are provisioned and running in private subnets 224, which are secure and isolated from the internet.

The application running in the EC2 instances 206 establishes the connection with amazon relational database service (Amazon RDS) for MySQL database instance 226 running in a private subnet, for example, database subnet 228, and only allows to accept a connection request from the EC2 instances 206. The database instance 226 stores and manages the information about properties’ availability, customer reviews, etc. Artifacts for property images, visitor documents, etc., are stored and accessible from S3 bucket 208, which could be accessed by the application running in the EC2 instances 206. The standard search is performed on the server 102 and the advanced multi-unit search is performed by AWS Lambda Function 230.

The server 102 makes an HTTP request 230 to the Lambda function 230 providing the visitor’s search data. The lambda function 230 analyses data and solves the complex algorithm for finding the optimal lodging for the visitor in case of internal and external moves. When the server 102 creates all possible accommodations, a response is sent to the visitor’s device 104 through cloudflare® 212. For monitoring and logging, the system includes a monitoring service. The monitoring service, for example, Amazon® CloudWatch is configured for EC2 instances 206 and RDS to check critical information like system utilization, performance, errors, etc. The monitoring service includes CloudWatch metrics 234 and CloudWatch logs 236, which contains infrastructure metrics and application logs metrics of the infrastructure for monitoring and alerting. The system further includes system manager 238 for system management and VPC flow logs 240 to capture information related to the network flows sent from and received by the VPC 210.

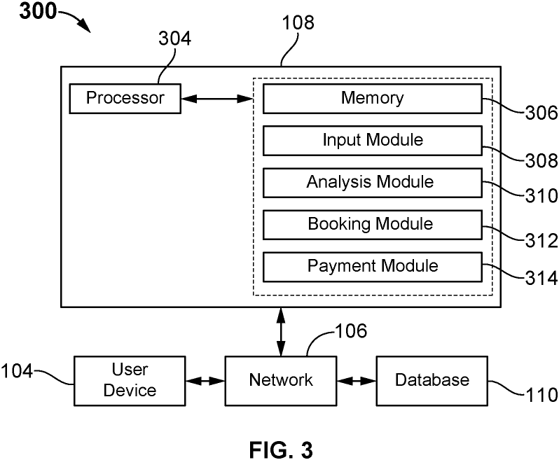

FIG. 3 exemplarily illustrates a block diagram 300 showing the components and connection between the components of the server 102, according to an embodiment of the present invention. The server 102 comprises the computing device 108 and at least one database 110. The computing device 108 comprises the processor 304 and the memory 306. The memory 306 stores a set of program modules executable by the processor 304. The set of modules includes an input module 308, an analysis module 310, a booking module 312 and a payment module 314. The input module 308 is configured to receive a request data for placement strategy from the visitor. The request data comprises check-in date, check-out date, a location of interest and optionally criteria (filters) for amenities. Criteria for amenities can be expressed either as mandatory requirements (must have) or as a monetary criterial value that is the penalty that a visitor imposes on a home for not having this particular amenity. The location of interest refers to the location that the visitor planned to visit. The request data, optionally, comprises a criterial value of each amenity, monetary value for lodging unit, criterial value to commute from the lodging unit to the location of interest, criterial value for moving from one lodging unit to another lodging unit.

For example, an amenity of the request data may have a value 0 to 100, and the visitor may provide a value 20. In one example, the criterial value represents importance of the criteria. In another example, the criterial value represents a monetary value of this criterion, that is the penalty that a visitor imposes on the lodging unit in the absence of particular amenity. In addition, the request data can have monetary criterial values for penalties that a customer imposes for moving during the total reservation either internally within the same location, i.e., a house (internal move penalty) or externally (external move penalty) to other location during the reservation. Moreover, a criterial monetary value can be assigned to a commute distance or time of an accommodation to the visitor’s point of interest, that is a penalty that the visitor imposes for the commute to the point of interest.

The analysis module 310 is configured to determine one or more placement strategies based on the request data. Each placement strategy comprises at least one lodging unit or a sequence of lodging units. Further each placement strategy includes information about moving from one lodging unit to another lodging unit within the found sequence. The system enables the visitor to create reservation that unites reservations inside one address connected by internal moves to one reservation on the property, i.e., a parent property.

Further, each placement strategy comprises a score (criterial value) to represent an optimal level of the placement strategy. The score value is based on the presence or absence of specified filters by increasing the value in the case of absence. The score value enables the visitor to evaluate and identify optimal placement strategy. The booking module 312 is configured to enable the visitor to review one or more placement strategies and select one placement strategy. The payment module 314 is configured to enable the visitor to make payment for the selected lodging strategy. The payment is sent to the management firm that pays to a host.

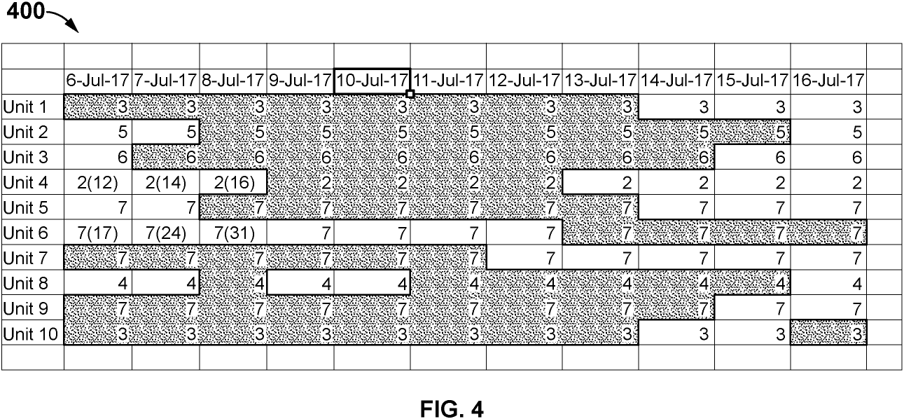

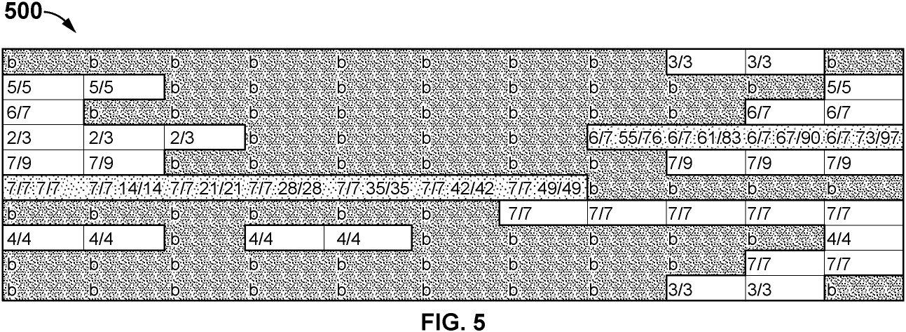

Referring to FIGS. 4-5, analysis tables (400 and 500) are shown before and after determining a path using an algorithm, respectively. In one aspect, the system also comprises an algorithm for determining the best path for the visitors. In one example, the algorithm finds such pathways using Bellman’s dynamic programming approach. In one embodiment, the system includes an analysis table for utilizing an algorithm to discover the pathways. In one embodiment, the analysis table includes the visitor’s trip dates as well as the units or rooms available in the residential premises, or accommodation. In one embodiment, the table 400 displays the analyses for each specific day in each individual unit in the system prior to determining the path (as shown in FIG. 4). Referring to FIG. 5, the table 500 displays the analyses for each specific day in each individual unit as well as the visitor’s transfers between units in the system after determining the path.

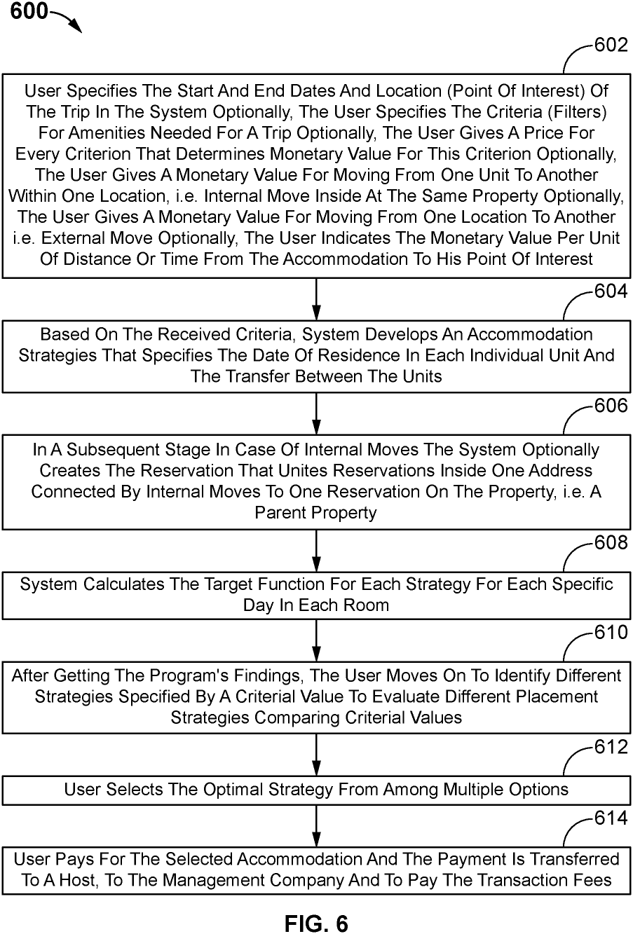

FIG. 6 exemplarily illustrates a flowchart of a method 600 for determining optimal placement strategy and booking accommodation, according to an embodiment of the present invention. At step 602, a visitor specifies the start and end dates and location (point of interest) of the trip in the system. Optionally, the visitor specifies the criteria (filters) for amenities needed for a trip, some criteria are specified as mandatory and some criteria are specified as useful but not absolutely necessary giving a monetary criterial value for useful criteria that define a penalty for not having this criteria. Optionally, the visitor gives a criterial monetary value for moving from one unit to another within one location, i.e., internal move inside at the same property. optionally, the visitor gives a criterial monetary value for moving from one location to another i.e., external move. optionally, the visitor indicates the monetary value per unit of distance or time for commute from the accommodation to his point of interest.

In one embodiment, the accommodations include, but not limited to, an apartment, a studio, a room, a bed, and so forth. In one embodiment, the criteria mentioned by the visitor include, but not limited to, reviews about the quality of the services provided, availability of a private or shared bathroom (i.e., toilet, dining room, etc.), size of the beds, and/or any other services, such as the presence of the Internet, cable or TV, network, jacuzzi, and so on.

At step 604, the system develops a placement strategy that specifies the dates of residence in each individual unit and the transfers between the units based on the received criteria. As a result of development, the application outputs variety of placement strategies.

At step 606, in case of internal moves, the system optionally creates the reservation that unites reservations inside one address connected by internal moves to one reservation on the property, i.e., a parent property.

At step 608, the system calculates the target function (i.e., the criterial value) for each strategy for each specific day in each room. In the base case, this target function is the sum of the cost of living in each room during travel plus the sum of the costs of moving into a new room, including cleaning the room. In a more complex version, the cost of living per day is adjusted at the price of adjustments for the provision of services to the visitor. The service for the visitor is a convenience (amenity), such as a private bathroom. The convenience also includes the proximity of the premises to a place that is the main purpose of the visitor’s trip, for example, a university. The target function for a particular state (defined by a rental unit and date) within a strategy does not change during further analysis in accordance with the Bellman dynamic programming. The main idea of dynamic programming is that at each step the optimal strategy for the next step is calculated.

Following the program’s outcomes, the visitor discovers different options at step 610. In one embodiment, each approach is specified by a criterial value. As a consequence of the computation, the visitor in this situation, the one seeking for premises, obtains a certain number of strategies. Each strategy has a price; that is, by looking at the strategy, the visitor may determine the price that must be paid for the plan. In one embodiment, the visitor may choose any of the tactics that he or she believes is the best of the available options. An analogy is when a person is searching for ticket flights from one location to another and sees the different ticket options that differ in prices and number of airport transfers. Moving between dwellings like this will very often helps to find the best placements, or in many cases it can find the only possible placements, because all the possibilities with one room can be occupied.

In one embodiment, the unit daily prices used in the optimization algorithm for a visitor’s accommodation can be recalculated based on the visitor input. For example, one type of space (i.e., set by the landlord) such as an apartment, costs $98 per day. This type of space (i.e., an apartment) may include or allow the visitors to use a washing machine, an extra bed, and other amenities. It can also be in short walking distance to the point of interest of the visitor, for example a university where the visitor studies. The visitor may indicate their estimate (for example, through the use of appropriate web forms) to pay an additional $28 for the short walking distance, $5 for the washing machine, and $3 for the extra bed. As a result, the criterial value for the day will be 98-20-5-3=60. Similarly, another apartment can cost $75 but be in a long distance from the university, has an extra bed but does not have a washing machine. Thus, the criterial value will be $75-5 = 70. Hence, from the visitor perspective, the 1st apartment has more value than the 2nd one despite having the higher nominal price. In one embodiment, the criterial value is used to determine the best possible placement.

At step 612, visitor selects the optimal strategy from among multiple options.

At step 614, the visitor pays for the chosen lodging, and the money is transmitted to the management firm and then to a host. Further, the transaction costs are paid. In one embodiment, the system also determines the best strategy for selecting residential properties, taking into consideration the move from one residential property to another over the course of the trip and adjusting the price to reflect the services offered to the guest. By analogy, such a move from one room to another is similar to a situation when a person flies and does not take a direct plane ticket from one city to another, but makes a transfer.

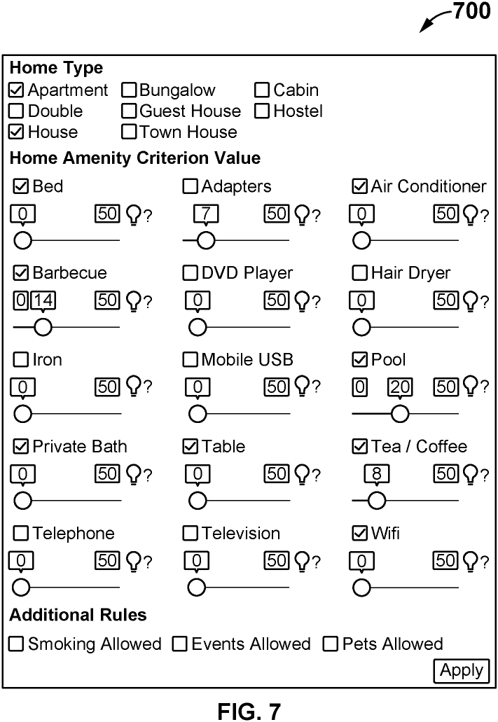

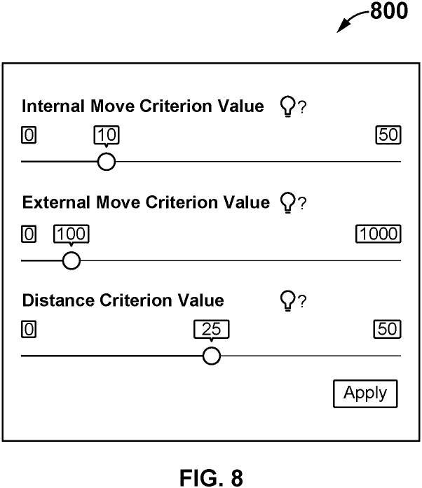

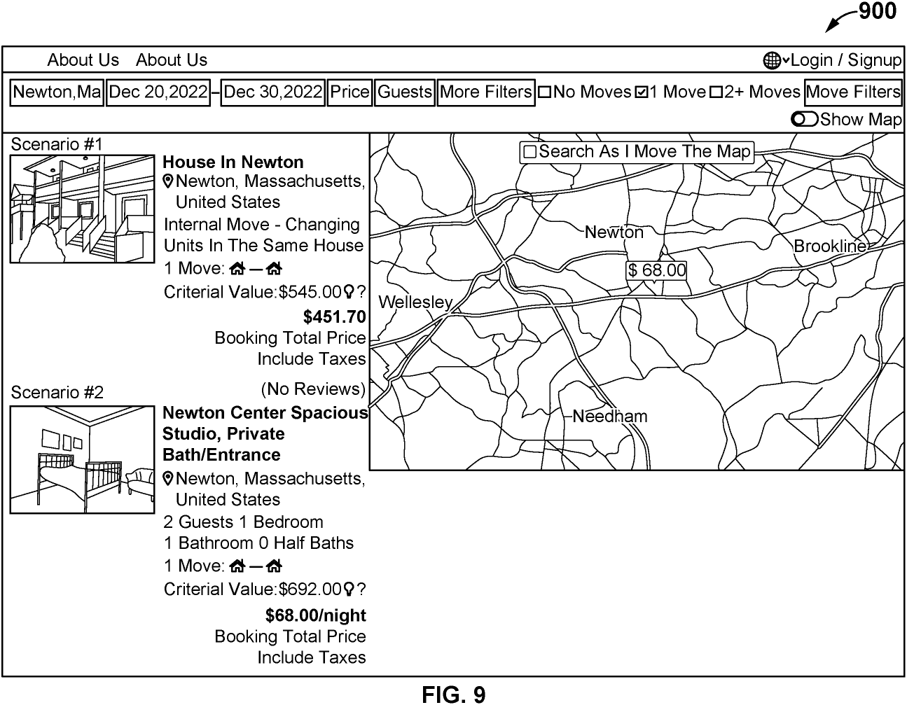

FIG. 7 shows a screenshot 700 of a user interface for specifying amenities needed and optionally setting a criterial value for a useful but not necessary amenity by the visitor, according to an embodiment of the present invention. The system uses both Boolean form and monetary form to specify amenities. The criterion value of 0 refers to the mandatory amenities defined by the visitor, and the range of positive values refers to the penalty imposed by the visitor for not having the useful but not necessary amenities. In the current example, the amenities including bed, air conditioner, private bath, table, and Wi-Fi has 0 as the criterial value to indicate mandatory amenity. The amenities including barbeque, pool, tea/coffee have criterial values ranging between 8 to 20 to indicate the penalty imposed by the visitor for not having the amenity. FIG. 8 shows a screenshot 800 of a user interface for optionally giving criterial monetary values for internal move, external move and distance or time for the commute from the accommodation to the point of interest. The system enables the visitor to set a price for being in a distance from a point of interest. The further the distance for the commute from the point of interest, the higher the criterial price. The system further enables the visitor to set a price for an external move. The higher criterial price refers to less willingness of the visitor to move. The system further enables the visitor to set a price for a move inside the same property. The higher criterial price refers to less willingness of the visitor to move. FIG. 9 shows a screenshot 900 of different placement strategy specified by a score value, according to an embodiment of the present invention.

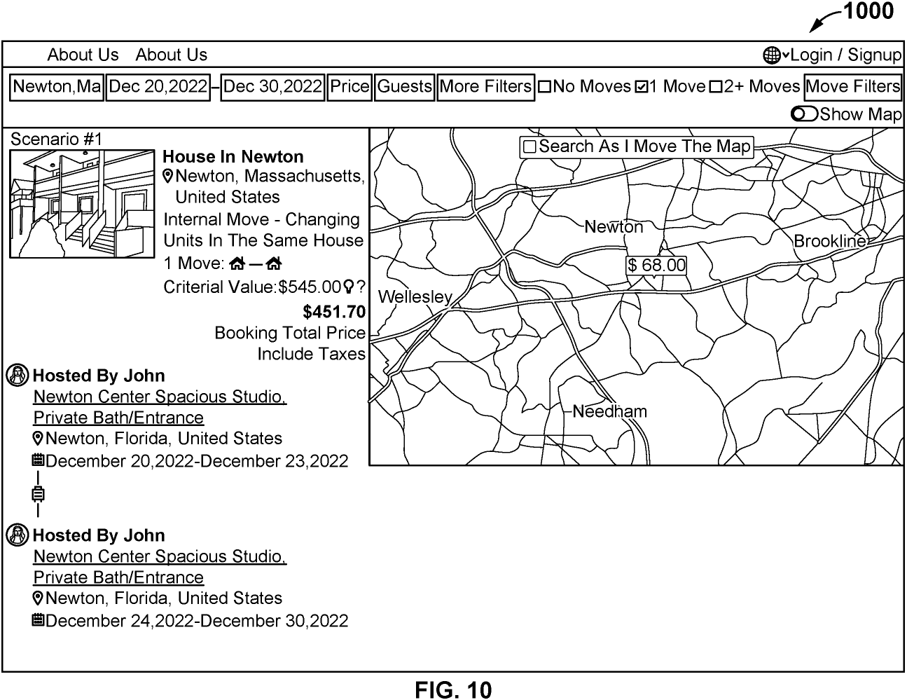

FIG. 10 shows a screenshot 1000 of a user interface of the visitor reservation that unites reservations inside one address connected by internal moves to one reservation on the property, or lodging unit, according to embodiment of the present invention.

Advantageously, the present invention assists in determining the optimal accommodation location for the visitors lodging. In addition, the present invention introduces the parent unit feature, which allows for the system to create one single booking for strategies with internal moves. Thereby, the present invention saves the expenses for extra reservation, such as the fixed fee from visitor’s transaction fee, thus reducing the total amount of the booking. The computer-implemented system and method allows the visitor to locate the best possible lodging. Furthermore, the system finds the best price for the specified premises taking into account the visitor’s criteria, thus giving priority to strategies with internal moves or without moves between different lodging unit. Furthermore, the system assures high occupancy rate of premises filling the gaps in a fragmented premises schedule. The system and method of the present invention help to find the best placement for the accommodation of the visitor in individual units and transfer between the units. The computer-implemented system and method provide an opportunity to find the optimal accommodation for the visitor. Also, the system increases the premises occupancy rate filling in the schedule gaps between previously occupied dates.

Preferred embodiments of this invention are described herein, including the best mode known to the inventors for carrying out the invention. It should be understood that the illustrated embodiments are exemplary only and should not be taken as limiting the scope of the invention.

The preceding description includes exemplary examples of the present invention. After describing example embodiments of the current invention, those knowledgeable in the art should be aware that the disclosures contained within are illustrative only, and that numerous other alternatives, adaptations, and changes may be made within the scope of the present invention. Simply stating or numbering the stages of a technique in a specific sequence does not impose any restrictions on the order of those steps. With the advantage of the teachings in the above descriptions, one knowledgeable in the art to which this invention belongs will have many changes and other embodiments of the invention spring to mind. Although particular terminology may be used in this document, they are solely intended in a generic and descriptive sense and not for the purpose of limiting. As a result, the current invention is not restricted to the precise embodiments depicted below.

What is claimed is:

1. A system for determining optimal placement strategy and booking accommodations, comprising:
a visitor device associated with a visitor, and
a server comprising a database and a computing device in communication with the database, the server is in communication with the visitor device, the database for storing information related to a plurality of lodging units and the visitors, the computing device comprises a memory unit storing a set of modules and a processor configured to execute the modules, the set of modules comprises:
an input module configured to receive a request data for placement strategy from the visitor;
an analysis module configured to determine one or more placement strategies based on the request data, each placement strategy containing one or a sequence of lodging units and includes information about moving from one lodging unit to another within the found sequence;
a booking module configured to enable the visitor to review one or more placement strategies and select at least one lodging unit, and
a payment module configured to enable the visitor to make payment for the selected lodging units.

2. The system of claim 1, wherein the request data comprises check-in date, check-out date, the location of interest and criteria for amenities.

3. The system of claim 1, wherein the request data, optionally, comprises mandatory necessary amenities, a criterial monetary value of useful but not necessary amenity, monetary value for lodging unit, criterial monetary value for commute from the lodging unit to the location of interest, criterial monetary value for moving from one lodging unit to another lodging unit internally within one address, criterial monetary value for moving from one lodging unit to another lodging unit externally to a different address.

4. The system of claim 1, wherein an amenity criterial value represents the visitor defined penalty for not having this amenity.

5. The system of claim 1, wherein each placement strategy comprises a score to represent an optimal level of the placement strategy, the score value enables the visitor to select optimal placement strategy.

6. The system of claim 1, wherein if the visitor selects movement between one lodging unit and another lodging unit within the address, the system unites reservations of these lodging units and creates the parent unit reservation substituting these lodging units’ reservation by one reservation.

7. A method for determining optimal placement strategy and booking accommodations, comprising the steps of:
providing a visitor device associated with a visitor, and a server comprising a database and a computing device in communication with the database, the server is in communication with the visitor device, the database for storing information related to a plurality of lodging units and the visitors, the computing device comprises a memory unit storing a set of modules and a processor configured to execute the modules;
receiving, via an input module at the computing device, a request data for placement strategy from the visitor;
determining, via an analysis module at the computing device, one or more placement strategies based on the request data, each placement strategy containing one or a sequence of lodging units and includes information about moving from one lodging unit to another within the found sequence;
enabling, via a booking module at the computing device, the visitor to review one or more placement strategies and select at least one lodging unit, and
enabling, via a payment module at the computing device, the visitor to make payment for the selected lodging units.

8. The method of claim 7, wherein the request data comprises check-in date, check-out date, location of interests and one or more amenities.

9. The method of claim 7, wherein the request data, optionally, comprises mandatory necessary amenities, a criterial monetary value of useful but not necessary amenity, monetary value for lodging unit, criterial monetary value for commute from the lodging unit to the location of interest, monetary value for moving from one lodging unit to another lodging unit internally within one address, monetary value for moving from one lodging unit to another lodging unit externally to a different address.

10. The method of claim 7, wherein an amenity criterial value represents the visitor defined penalty for not having this amenity.

11. The method of claim 7, wherein the placement strategy comprises a score to represent an optimal level of the placement strategy, the score value enables the visitor to select optimal placement strategy.

12. The method of claim 7, wherein if the visitor selects movement between one lodging unit and another lodging unit within the address, the system unites reservations of these lodging units and creates one parent unit reservation.
